(19) United States
(12) Patent Application Publication
(10) Pub. No.: US 2024/0080570 A1
(43) Pub. Date: Mar. 7, 2024

(54) METHOD FOR FIELD-DEPENDENT ALIGNMENT OF IMAGING OPTICS TO SIMILAR-APERTURE ILLUMINATION SYSTEM

(71) Applicant: QUALITY VISION INTERNATIONAL INC., Rochester, NY (US)

(72) Inventor: Daniel James Lawler Williams, Rochester, NY (US)

(21) Appl. No.: 18/201,417

(22) Filed: May 24, 2023

Related U.S. Application Data
(60) Provisional application No. 63/345,465, filed on May 25, 2022.

(51) Int. Cl. H04N 23/74; G06V 10/141; G06V 10/60

(52) U.S. Cl. CPC H04N 23/74; G06V 10/141; G06V 10/60

(57) ABSTRACT

An optical alignment system having a field of view comprising an illumination system having an illumination pupil and a light source, wherein the illumination system produces a first illumination angular distribution having a first illumination axis, an imaging system having an imaging sensor comprising at least one detector element, and an imaging pupil, and an acceptance cone of the imaging system having an optical axis, wherein at least a portion of the imaging pupil is filled by the illumination system output when a portion of the first illumination angular distribution overlaps with the acceptance cone, and a first tapered substrate having a first tapered and transmissive surface, the first tapered substrate removably disposed in object space between the illumination system and the imaging system, wherein the tapered substrate is rotated and a change in signal intensity is monitored to quantify field dependent alignment between the illumination system and the imaging system.

### BACKGROUND OF THE INVENTION

### Field of the Invention

This invention relates to optical measurement machines for gathering metrological data from test objects and in particular, to methods and systems for detecting field dependent alignments between an imager and an illuminator of an optical measurement machine having a rotationally symmetric angular distribution of light.

### Description of Related Art

Optical measuring systems for gathering metrological data from test objects allow measurements to be made without contacting the test object being measured. U.S. Pat. Nos. 10,701,259 and 9,784,564 teach various aspects of certain video measurement machines and are incorporated herein by reference in their entirety. One way optical measurement machines gather metrological data is by “backlighting” the test object. For example, the test object is illuminated by an illumination system from one direction and the test object is imaged by an imaging system from the opposite direction. When backlighting a test object, the test object itself appears dark to the imaging system and the remaining background appears light. Thus, the test object appears in silhouette. The object profiles are then identified by the points of transition between light and dark, where the light that surrounds or passes through the test object is contrasted with adjacent portions of the view at which light is blocked. Backlights of video measuring machines are typically designed to form a rotationally symmetric illumination distribution to maintain isometry. Typically, such optical imaging systems further include a rotationally symmetric imaging pupil transmission function.

Optical imaging systems have the complication of being sensitive to proper lighting of the part being measured, which is achieved in part, by proper alignment of an illumination system and imaging system of the optical imaging system. In optical imaging systems having a low numerical aperture (NA) illumination system and a low numerical aperture (NA) imaging system, aligning the two systems is difficult. Typically, a first adjustment of the relative angle and translational position between the two systems is made to permit some transmission of light through the system. Then, smaller adjustments are made to determine the highest transmission of light by maximizing the transmitted signal intensity on the sensor of the imaging system. That is, the intensity incident on the sensor of the imaging system depends on the alignment between the central axis of an illumination distribution to the central axis of the acceptance cone of the imaging system. Misalignment of the imaging system and illumination system results mostly in a reduced intensity on the imaging sensor due to a smaller area of overlap between the illumination distribution and the acceptance cone of the imaging system. In a misaligned system, the illumination axis of symmetry may be non-parallel to the imaging acceptance cone axis. While the process of random hunting (i.e., tip/tilt) in two-dimensional space provides an approximate alignment of the illumination system to the imaging system, it is unknown when the maximum intensity is reached since there is no feedback on which adjustments should be made to improve alignment, except for perceived historical changes as a function of manual adjustments. That is, the gradient of transmitted intensity is a function of a given adjustment. Thus, if optimal alignment is reached, there is no indicative feedback until the system is adjusted out of best alignment. Even if the adjustments are confined to angular ones (assuming the illuminator spatially and uniformly overfills the imager entrance pupil), nearly-random hunting in a two-dimensional space is time consuming and prone to error. Further, the point of local maximum transmission of light does not necessarily correspond to the best alignment.

Moreover, it is often assumed that the imaging system and the illumination system are each telecentric in object space. This would provide that there is no field dependence of the angular misalignment such that the intensity is uniform across the field of view for any given angular misalignment. In practice, however, intensity can vary across the field of view, for example, when the illumination system's output is slightly convergent or divergent.

### BRIEF SUMMARY OF THE INVENTION

An optical alignment system having a field of view comprises an illumination system having an illumination pupil and a light source configured to generate an output, wherein the illumination system produces a first illumination angular distribution having a first illumination axis, wherein the first illumination angular distribution is generally rotationally symmetric, an imaging system having an imaging sensor comprising at least one detector element, an imaging pupil, and a first acceptance cone in object space of the imaging system having an optical axis, wherein at least a portion of the imaging pupil is filled by the illumination system output when a portion of the first illumination angular distribution overlaps with the first acceptance cone, and a first tapered substrate having transmissive surfaces, the first tapered substrate removably disposed in object space between the illumination system and the imaging system, wherein the tapered substrate is rotated and a change in signal intensity is monitored to quantify field dependent alignment between the illumination system and the imaging system (i) in a first region of the image sensor corresponding to a first location or a first portion of the first tapered substrate within the field of view; and (ii) in a second region of the image sensor corresponding to a second location or a second portion of the first tapered substrate within the field of view.

A method of quantifying a field dependent alignment of an illumination system in an optical alignment system having a field of view is also provided. The method comprises the steps of producing an output from a light source of the illumination system having an illumination pupil and a collimation lens, the output having an illumination distribution having an illumination axis, receiving by an imaging system the output from the illumination system, the imaging system having an imaging sensor, an imaging pupil and an acceptance cone having an optical axis, wherein at least a portion of the imaging pupil is filled by the output, rotating a first tapered substrate having a thickness gradient between the illumination system and an imaging system about a substrate axis that is substantially perpendicular to the first tapered substrate and substantially parallel to at least one of the illumination axis and the optical axis, the first tapered substrate located in object space, and monitoring intensity changes on a first region of the image sensor corresponding to the first tapered substrate at a first location within the field of view and a second region of the image sensor corresponding to the first tapered substrate at a second location within the field of view to quantify field dependent alignment between the illumination system and the imaging system.

In one example embodiment, the method further comprises the steps of rotating the first tapered substrate between the illumination system and the imaging system about a substrate axis that is substantially perpendicular to the first tapered substrate and substantially parallel to at least one of the illumination axis and the optical axis, the first tapered substrate located in object space between the illumination system and an imaging system, detecting on an image sensor whether changes in transmitted intensity in the imaging system occur as the first tapered substrate is rotated, and if changes in transmitted intensity are detected, determining a direction and relative magnitude of misalignment between the illumination system and imaging system.

### BRIEF DESCRIPTION OF THE SEVERAL VIEWS OF THE DRAWING(S)

FIG. 1 is a schematic layout of an optical measurement system in accordance with an embodiment of this invention.

FIG. 2 is a schematic view of the optical measurement system of FIG. 1 showing an imaging system and an illumination system.

FIG. 3 is a schematic view of an imaging system and illumination system that are misaligned with respect to each other.

FIG. 4 is a schematic view of an optical measurement system having a wedge window for optimizing an alignment position of the imager and illumination system.

FIG. 5A is a schematic view of the imager system and illumination system of FIG. 2 without a field-dependent alignment and showing a tapered substrate in substantially the entire field of view.

FIG. 5B is a schematic view of the imager system and illumination system of FIG. 2 having a field-dependent alignment and showing a tapered substrate in substantially the entire field of view.

FIG. 6A is a schematic view of the imager system and illumination system of FIG. 2 having a field-dependent alignment and showing a tapered substrate in a first position in the field of view.

FIG. 6B is a schematic view of the imager system and illumination system of FIG. 2 having a field-dependent alignment and showing a tapered substrate in a second position in the field of view.

FIG. 6C is a schematic view of the imager system and illumination system of FIG. 2 having a field-dependent alignment and showing a tapered substrate in a third position in the field of view.

FIG. 7 is a top view of a wedge window for optimizing an alignment position of the imager and illumination system, the wedge window view having an arrow illustrating the direction of a thickness gradient.

FIG. 8 is a cross-sectional view of the wedge window for optimizing an alignment position of the imager and illumination system, taken along lines 7-7 of FIG. 7, the arrow illustrating the direction of the thickness gradient and a dashed line indicating a substantially perpendicular rotation axis.

FIG. 9A is a schematic view of the illumination system of FIG. 2 having an alignment with convergent illumination patterns.

FIG. 9B is a schematic view of the illumination system of FIG. 2 having an alignment with collimated illumination patterns.

FIG. 9C is a schematic view of the illumination system of FIG. 2 having an alignment with divergent illumination patterns.

FIG. 10A is an example of intensity data captured for a system with field-dependent alignment, the intensity shown along one line extending across the field of view and at a continuously varied rotation angle of a single tapered substrate in substantially the entire field of view as shown in FIGS. 5A and 5B.

FIG. 10B is a plot of three traces of the intensity of light on the image sensor at three positions in the field of view as a function of the rotation angle of the tapered substrate corresponding to the intensity at the three marked field of view positions in FIG. 10A.

FIG. 11 is a plot of intensity change with misalignment of the imaging system of FIG. 2 with a pupil angular extent of ±1 arb. unit and an angularly uniform illuminator of angular extent ±2 arb. units, wherein the relative area of overlap of the angular extent defined by the pupil of the imaging system and the angular extent of the angularly uniform illuminator is shown as a function of the center separation distance.

FIGS. 12A-12E are representations of regions of a field of view showing misalignment directions of the illuminator to determine a field-dependent alignment or field-independent misalignment.

FIG. 13 is a flow chart showing an exemplary method in accordance with an embodiment of the invention.

FIG. 14 is a flow chart showing an exemplary method in accordance with an embodiment of the invention.

FIG. 15 is a flowchart showing an exemplary method in accordance with an embodiment of an invention.

### DETAILED DESCRIPTION OF THE INVENTION

At the outset, it should be appreciated that like reference numbers are intended to identify the same structural elements, portions, or surfaces consistently throughout the several drawing figures, as such element, portions or surfaces may be further described or explained by the entire written specification, of which this detailed description is an integral part. Unless otherwise indicated, the drawings are intended to be read together with the specification, and are to be considered a portion of the entire written description of this invention.

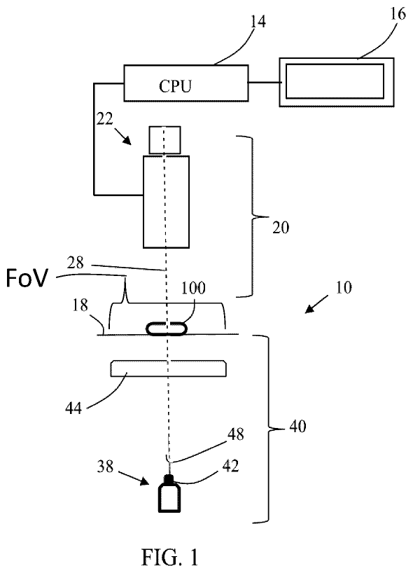

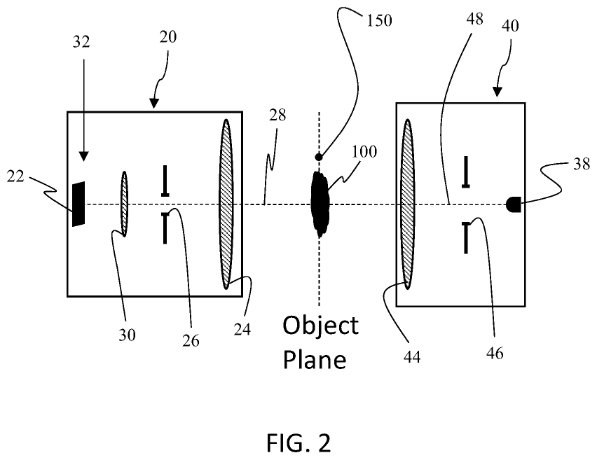

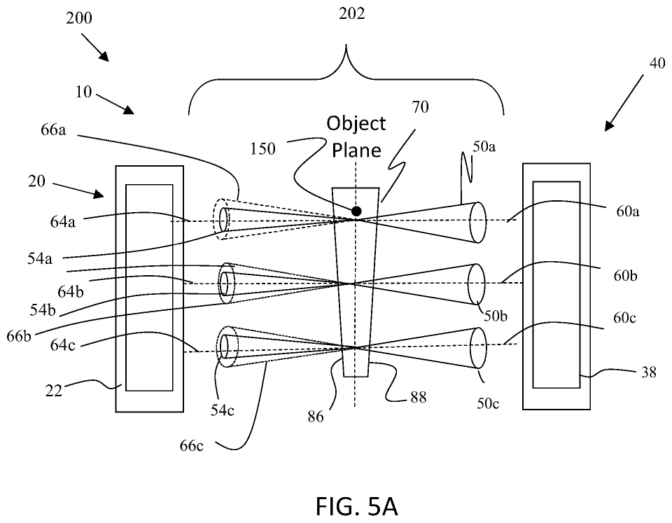

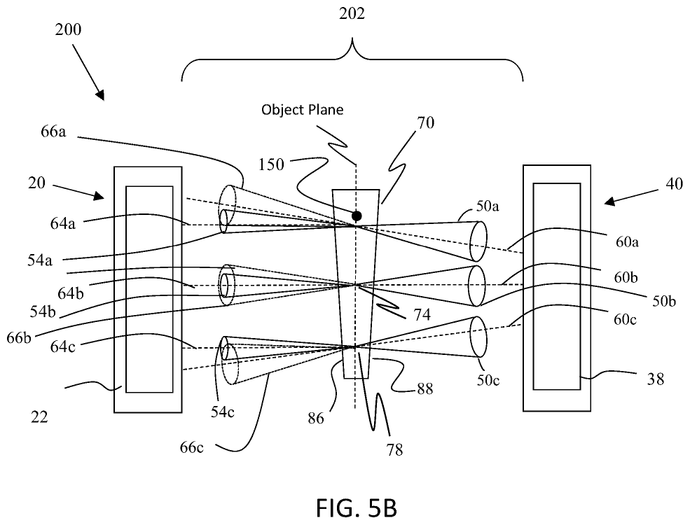

FIGS. 1 and 2 are schematic layouts of an optical measurement system 10 for measuring a test object 100 with an imaging system 20 which is aligned with an illumination system 40 using a tapered substrate 70 (for example, as shown in FIGS. 5A and 5B, FIGS. 6A-6C, FIG. 7 and FIG. 8) in accordance with one aspect of this disclosure. The imaging system 20 is arranged for detecting transmitted light from the illumination system 40 on the opposite side of the test object 100, producing what is known as diascopic illumination. The imaging system 20 includes at least an imager 22, for example, an arrayed image sensor, which can be aligned along a common optical axis 28 of the optical measurement system 10. In one example embodiment, the arrayed image sensor is a 1-dimensional array. In another example embodiment, the arrayed image sensor is a 2-dimensional array. In one example embodiment, the imaging system 20 further includes at least one imaging objective lens 24 and an imaging pupil 26 produced by an aperture stop at that location. In an example embodiment, the imaging system 20 also includes a rear lens 30 with the imager 22 proximate to the image plane 32. Preferably, the imaging pupil transmission function is rotationally symmetric or near rotationally symmetric. Typically, the imaging system 20 has a substantially uniform (unity) transmittance over the angular extent of a circular aperture stop and a uniform, zero or substantially zero transmittance beyond that angular extent, which qualifies as a rotationally symmetric angular distribution. The optical measurement system 10 is illuminated by an illumination system 40, which is depicted in FIGS. 1 and 2 as a backlighting system. In an example embodiment, the illumination system 40 includes an illuminator 38 having a light source 42 providing an output beam of light and a collimating lens 44. The light source 42 in one example embodiment is a non-coherent light source. For example, in one example embodiment, the light source 42 is a light emitting diode (LED) or a plurality of LEDs. In another example embodiment, the light source 42 is an incandescent lamp, high intensity discharge (HID) lamp, or superluminescent diode (SLD or SLED).

Although one collimating lens is shown, it should be appreciated that additional optical components may be included. Typically, the collimating lens 44 is a lens with the back focal plane significantly coincident with the illumination pupil 46 so as to create collimated output within a finite angular extent. The illumination system 40 further includes an illumination pupil 46 produced by an aperture stop at that location and an illumination axis 48 produced by the alignment of the illumination pupil 46 and the collimating lens 44. The illumination system 40 in one example embodiment is aligned with the optical axis 28, sometimes considered the centerline of the optical measurement system 10. The objective lens 24 of the imaging system 20, together with the collimating lens 44 of the illumination system 40, images the illumination pupil 46 of the illumination system 40 onto the imaging pupil 26 of the imaging system 20. It should be appreciated that the illumination distribution of the illumination system 40 preferably has a rotationally symmetric angular distribution about the illumination axis 48 to maintain isometry. Typically, the angular extents of the imaging system 20 and illumination system 40 are relatively small and similar in magnitude. For example, in one example embodiment, the angular extent of the imaging system 20 ranges from ±0.1 to +3.0 degrees and the angular extent of the illumination system 40 ranges from +0.1 to +3.0 degrees. In one example embodiment, the angular distribution of the illumination system 40 is nearly constant over the field of view of the imaging system 20. In one example embodiment, the angular extent of the illumination system 40 exceeds the angular extent of the imaging system 20. In one example embodiment, the angular distribution of the illumination system and the acceptance cone of the imaging system 20 are nearly constant over the field of view of the imaging system 20.

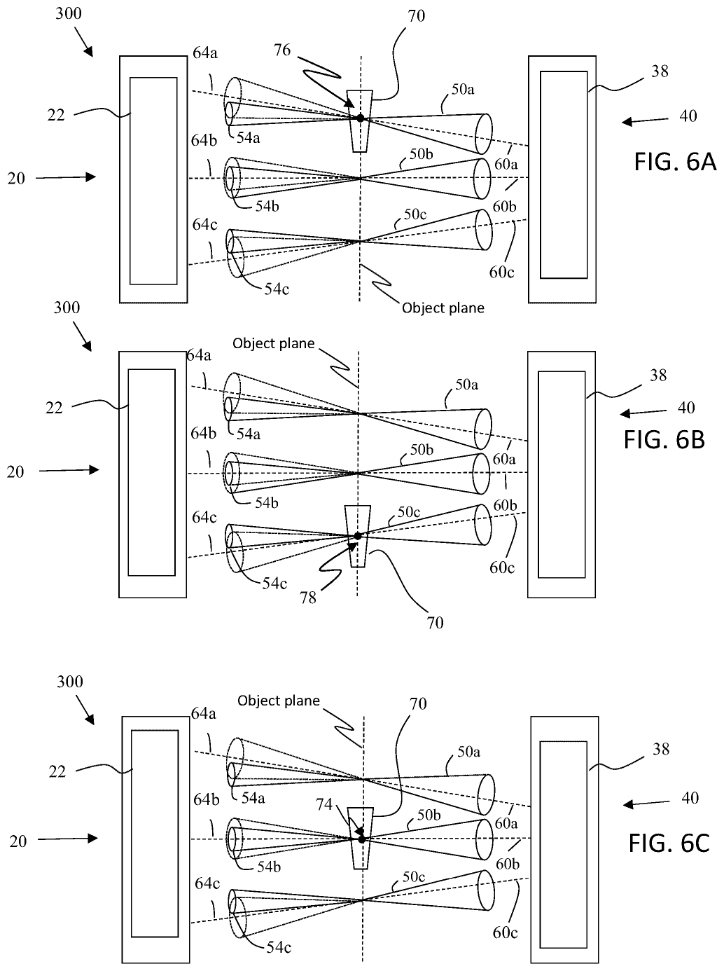

In one example embodiment, the imaging system 20 and illumination system 40 are in communication with a central processing unit 14 (also referred to hereinafter as CPU 14 or processor 14 or computer 14) which communicates with a display 16. The CPU 14 may be a computer programmed to position the object by adjusting a stage 18, set the magnification, adjust the illumination levels for each light source, adjust the position of the illumination pupil 46, adjust the position of the illumination system 40, adjust the position of the imaging system 20, and aid in determining the location and dimensions of features of the object 100 based on a video signal produced by the imaging system 20. In an example embodiment, the elements of the imaging system 20 are controlled by a computer 14 which is the same computer 14 that determines the location and dimensions of the features of the test object 100. The CPU 14 may further monitor intensity changes on a plurality of regions of the arrayed image sensor 22 corresponding to locations of the tapered substrate 70 also referred to as an optical window or wedge window 70 (for example, as shown in FIGS. 5A-6C) within the field of view to quantify a field-dependent alignment between the illumination system 40 and the imaging system 20.

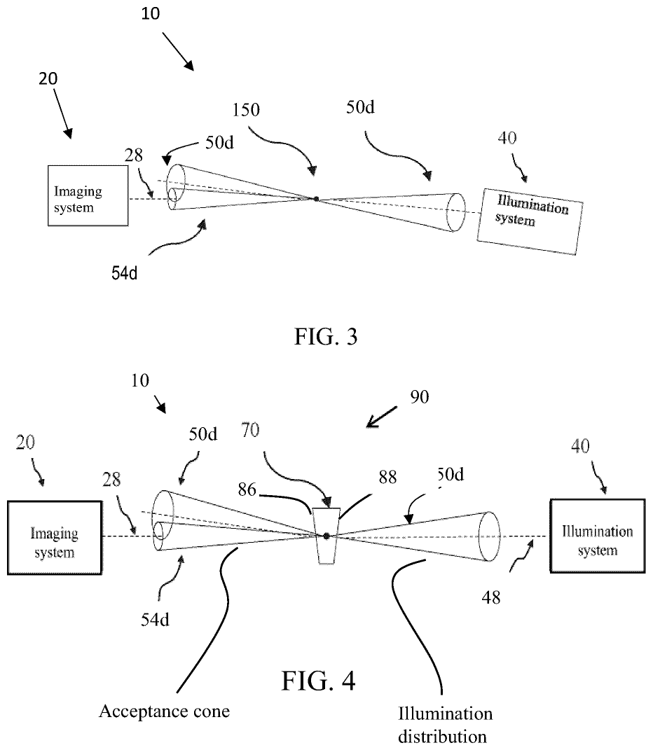

FIG. 3 is a schematic layout of a generic optical measurement system 10 illustrating the alignment procedure when the illumination system 40 and imaging system 20 are misaligned. In this example, the imaging system 20 will preferably receive any light from object plane point 150 that falls within its acceptance cone 54d. Because the illumination angular distribution 50d does not completely cover the acceptance cone 54d, the pixels of the imager 22 associated with the exemplary point in the object plane 150 will receive less light than they would if the system 10 were aligned. If the illumination angular distribution 50d and imaging system's transmission function are uniform within their respective extents, the intensity of light striking the imager 22 is proportional to the area of overlap of the illumination angular distribution 50d and the acceptance cone 54d.

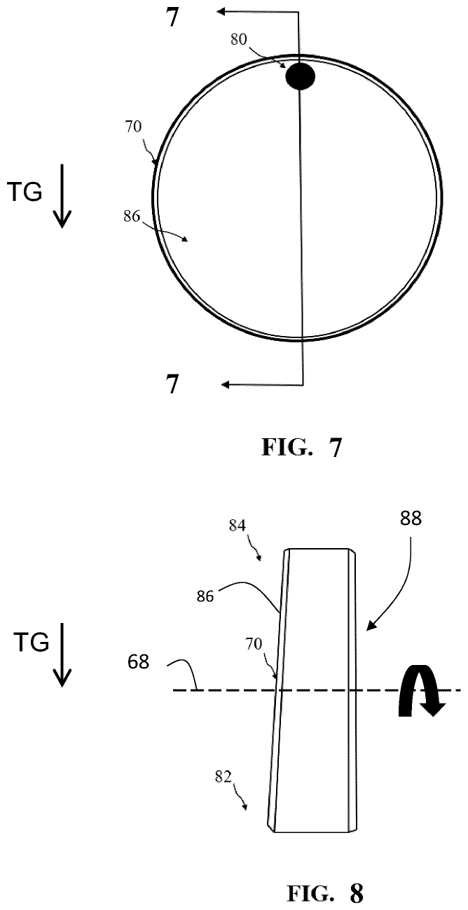

Turning now to FIG. 4, to align the optical measurement system 10 using the optical measurement alignment system 90, the illumination from the illumination system 40 is deviated by a constant polar angle and a variety of azimuthal angles. In one configuration, this controlled deviation is achieved by inserting a substrate having tapered transmissive surfaces in the object plane as shown in FIG. 4. For example, the substrate in one configuration is a wedge window 70, as shown in FIGS. 7 and 8 and described above.

As shown in FIG. 4, to optimize the alignment of the imaging system 20 and the illumination system 40 of an optical measurement system 10, a plurality of controlled and temporary misalignments, that is deviation of the illumination by a constant polar angle and a variety of azimuthal angles, are purposefully introduced using the substrate that can be adjusted within the system 10, such as wedge window 70. When the illumination distribution is misaligned with the optical axis 28 of the imaging system acceptance cone 54d in the absence of the substrate, a change in signal intensity from the imager 22 is generated by inserting and adjusting the substrate. Thus, the optical alignment system 90, using the adjustable substrate, provides feedback on the alignment of the imaging system 20 and illumination system 40. Such feedback provided by the optical alignment system 90 includes data on the transmitted intensity as a function of rotational position of the substrate, without making adjustments to the optical measurement system 10 itself. Moreover, the feedback identifies the adjustments needed to be made to provide a preferred optimized alignment.

As provided infra, the wedge window 70 deviates transmitted light by an angle that is largely insensitive to the angle of the incident light relative to the optical surfaces 86, 88. Thus, the optical window 70 does not need to be placed in object space at a precise angle. Additionally, the translational position of the wedge window 70 can be varied since the wedge angle and therefore, angle of deviation, is constant throughout the aperture of the imaging system 20. Finally, the axial position of the wedge window 70 can be varied provided the illumination system 40 covers a large enough spatial extent. If the spatial extent is small, however, it is preferable to place the window near the object plane to minimize signal loss due to translational displacement of the illumination relative to the imaging system 20.

Once the wedge window 70 is placed in the object plane of the system 10, the next step is to observe the relative intensity on the imager 22 as a function of the azimuthal deviation induced by the wedge window 70. The azimuthal angle is changed by adjusting the wedge window 70. In one configuration, the azimuthal angle is changed by rotating the wedge window 70 about an axis 68 approximately perpendicular to its front 86 and back 88 surfaces and approximately parallel to the optical axis 28. Rotating the wedge window 70 induces changes in the angle between the illumination axis 48 and the optical axis 28 if the system is misaligned, thus causing intensity changes on the imager 22; however, if the system is aligned, the angle between the axes of symmetry remains constant and equal to the wedge window deviation angle, resulting in a constant intensity on the imager 22. Once an optimal alignment of the imaging system 20 with respect to the illumination system 40 is achieved, the wedge window 70 is removed from the optical path.

An optimally aligned system consisting of a rotationally symmetric illumination angular distribution 50d and a rotationally symmetric acceptance cone 54d will show no change in pixel intensity as the wedged window 70 is rotated through a full rotation. This is because the wedge-induced angle between the illumination axis 48 and the optical axis 28 is constant for all azimuthal angles. Thus, the intersection of the two distributions provides a constant transmission of light.

As provided in FIG. 5A, the optical measurement system 10, using the optical alignment system 200, including but not limited to using a wedge window 70 sized to span substantially all of the field of view for alignment as disclosed herein, has an angular distribution of the illumination system 40 that is constant or nearly constant over a spatial extent that exceeds the spatial extent of the field of view of the imaging system 20. This reduces the alignment optimization to the two angular dimensions of relative angle as described below. Two exemplary optical measurement systems 10 for which the wedge window 70 may be used are the TurnCheck™ system and the Fusion® system, each available from Optical Gaging Products, Inc. However, it should be appreciated by those having ordinary skill that other optical measurement systems having measuring and video capabilities may be assessed for field dependent alignment using a rotating tapered substrate 70. By “field dependent alignment” it is meant to refer to alignment that varies with the position in the field of view. After the field dependent alignment is substantially eliminated or removed from the optical measuring system, the wedge window 70 may be used to align an imaging system 20 and an illumination system 40 of the system. An optical measurement system 10 that has field dependent alignment substantially eliminated or removed may be referred to as field independent. An optical measurement system 10 that has both the (i) field dependent alignment substantially eliminated or removed and (ii) the imaging system 20 and the illumination system 40 angularly aligned may be referred to as fully aligned.

That is, before a measurement of the test object 100 is taken, the alignment between the imaging system 20 and the illumination system 40 is typically optimized. The alignment between the imaging system 20 and the illumination system 40 is optimized when, for example, substantially parallel axes of rotational symmetry between the illumination angular distribution 50b of FIG. 5A and the imaging acceptance distribution 54b in object space are obtained. That is, the centerlines of the angular distributions are generally parallel to and in alignment with the centerlines of the acceptance cones throughout the field of view of the system 10.

In the example embodiments shown in FIGS. 1 and 2, the illumination system 40 and the imaging system 20 are considered aligned if the illumination axis 48 aligns with the optical axis 28. However, it is assumed here that both the imaging system 20 and the illumination system 40 are telecentric in object space; that is, the centerlines of the acceptance cones and illumination cones, centerlines 64a, 64b, and 64c and centerlines 60a, 60b, 60c, respectively, have a constant direction across the field of view as shown in FIG. 5A. This would provide an alignment that is not field-dependent, and the intensity would be uniform across the field of view for any given misalignment of the imaging system 20 and the illumination system 40. However, as further described, in some optical measuring systems 10, either the imaging system 20 or the illumination system 40 is not telecentric and the intensity can vary across the field during an alignment analysis, indicating a field-dependent alignment between the illumination system 40 and imaging system 20, assuming the angular distribution does not vary significantly except in its centerline direction.

FIGS. 5A and 5B are schematic layouts of a generic optical measurement alignment system 200, which comprises the imaging system 20, the illumination system 40, and a tapered substrate 70 spanning a substantial portion of the field of view of the optical measurement system. While the position and extent of the tapered substrate 70 is shown in FIGS. 5A and 5B, its effect on the illumination angular distributions 66a, 66b, 66c is not depicted. The optical measurement alignment system 200 can be used to determine whether an adjustment to the distance between the collimation lens 44 and illumination pupil 46 in the illumination system 40 is needed to provide a well-collimated illumination system 40 before the imaging system 20 and the illumination system 40 are aligned (assuming the imaging system is telecentric). By providing a well-collimated illumination system 40, the variation of the intensity across the field during an alignment analysis will be substantially eliminated or diminished.

The imaging system 20 will preferably receive any light from object plane point 150 that falls within its acceptance cones 54a, 54b, 54c. Because the illumination angular distributions 50a and 50c do not completely cover the acceptance cones 54a and 54c in FIG. 5B, the pixels of the imager 22 associated with the a point 150 in the object plane will receive less light if it were located at the apex of the acceptance cone 54a or 54c, respectively, than it would if the centerlines 60a, 60c were aligned with centerlines 64a, 64c. The intensity of light striking the imager 22 is proportional to the area of overlap of the illumination angular distributions 66a, 66b, and 66c and the acceptance cones 54a, 54b, and 54c, respectively.

The illumination system 40 sends an output beam of light through object space 202 directly into the imaging system 20, which has an angular acceptance cone. In one example embodiment, the imaging system 20 includes an acceptance cone associated with each point in the object plane, for example, those represented by the angular acceptance regions 54a, 54b, and 54c, which represent the angular acceptance regions of the imaging system 20 as shown in FIGS. 5A and 5B. In one example embodiment, the imaging system 20 provided in the optical measurement system 10 is telecentric. That is, for the imaging system 20, the directions of the centerlines 64a, 64b, and 64c of the acceptance cones 54a, 54b, and 54c, respectively, are constant across the field of view for the imaging system 20 such that the imaging system 20 is telecentric in object space 202.

In an example embodiment, the illumination system 40 includes illumination angular distributions 50a, 50b, and 50c having centerlines 60a, 60b and 60c, respectively. If the centerlines 60a, 60b and 60c of the illumination system 40 have a constant direction across the field of view, as shown in FIG. 5A, there will be zero, or substantially zero, field dependence of any misalignment of the imaging system 20 and illumination system 40 assuming the imaging system 20 is telecentric in object space. In this example embodiment, the illumination angular distributions 50a, 50b, and 50c and the acceptance cones 54a, 54b, 54c, respectively, will have parallel, or substantially parallel center axes. That is, the centerline pairs 60a and 64a, 60b and 64b, and 60c and 64c will be parallel and the intensity for any given misalignment between the illuminator 40 and the imaging system 20 will be uniform across the entire field of view. If, however, the illumination system 40 has an illumination pupil 46 that is not in the telecentric axial position, the output beam of light may be convergent or divergent. For example, as shown in FIG. 5B, the centerlines 60a and 60c of the illumination system 40 are not substantially parallel with the centerlines 64a and 64c, respectively, providing a divergent output beam of light. As a result, during a rotating wedge analysis to determine a system misalignment between the illuminator 40 and the imaging system 20, the intensity detected on the image sensor 22 may vary across the field of view. Thus, in a system where angular distribution does not vary significantly except in the centerline direction, detecting such intensity variations using a tapered substrate 70 can indicate a field-dependent alignment between the imaging system 20 and the illumination system 40. To remove the field-dependent alignment, the axial position of the illumination pupil 46 can be adjusted before the rotating wedge analysis is once again performed to determine system misalignment between the imaging system 20 and illumination system 40. That is, once the illumination system 40 is well-collimated, the system will likely still be misaligned, but the misalignment magnitude and direction will be constant everywhere in the field of view. Such misalignment can then be corrected using additional techniques.

To detect the field dependent alignment of the optical measurement system 10 using the optical measurement alignment system 200 as shown in FIGS. 5A and 5B, the tapered substrate 70 is rotated and the output beam of light from the illumination system 40 is deviated by a constant polar angle and a plurality of azimuthal angles. In one example embodiment, this controlled deviation is achieved by rotating a tapered substrate 70 having transmissive surfaces 86, 88 in the object plane as shown in FIGS. 5A-5B. In one example embodiment, transmissive surface 86 is angled. In another example embodiment, transmissive surface 88 is also or alternatively angled. In an embodiment, the tapered substrate 70 includes a gradual diminution of thickness from one end of the substrate 70 to the other end of the substrate 70 providing a thick portion 82 and a thin portion 84. In one example embodiment, the tapered substrate 70 is rotated by a rotary indexer (not shown) of the optical measurement system 10. The substrate 70 in one example embodiment is a wedge window that spans substantially the entire field of view. Preferably, the wedge window spans at least 80% of the field, and more preferably at least 90% and still more preferably greater or equal to 100%. Having a tapered substrate 70 that spans substantially the entire field of view allows multiple, disparate regions of the field of view to be separately analyzed for alignment.

In another example embodiment, a field dependent alignment of the optical measurement system 10 is detected using the optical measurement alignment system 300 as shown in FIGS. 6A, 6B, and 6C. This optical measurement alignment system 300 comprises the imaging system 20, the illumination system 40, and a tapered substrate 70 spanning a portion of the field of view of the optical measurement. In this embodiment, the controlled deviation is achieved by inserting a wedge window as the tapered substrate 70, the wedge window having transmissive surfaces 86, 88 in at least three separate regions in the object plane, and then rotating the tapered substrate 70. Thus, instead of the wedge widow spanning a substantial portion of the field of view, the wedge window is sized to span a smaller portion of the field of view, and is moved to separate regions within the field of view, for example regions 74, 76, 78, to measure the intensity at such regions. In an example embodiment, the three separate regions comprise a center position and two field of view edge positions, each edge position located on opposite sides of the center position. Although three separate regions in the object plane are shown in FIGS. 6A-6C, it should be appreciated that the controlled deviation can be achieved by inserting a wedge window as the tapered substrate 70 in at least two separate regions in the object plane, and then rotating the tapered substrate 70. The at least two separate regions should be provided somewhere in object space, but do not necessarily need to be located in the object plane. The at least two separate regions should be separated laterally and the wedge window 70 should be substantially perpendicular to the optical axis 28. However, axial position along the optical axis 28 is not critical. In one example embodiment, the tapered substrate 70 is proximate the object plane.

Turning to FIGS. 7 and 8, the tapered substrate, or wedge window 70, includes a planar front surface 86 and a planar back surface 88 that have a small relative angle between their surface normals as illustrated in FIG. 8. Preferably, the surfaces 86, 88 are transmissive and have minimal reflectance. In one example embodiment, the front and back surfaces of the wedge window 70 are uncoated and have approximately 4% or less reflection per surface. It should be appreciated that a small wedge angle provides a mild refractive prism, deviating incident light rays by a small angle in a direction of the thicker portion of the wedge window 70. Unlike typical prisms with relative surface angles measured in tens of degrees, the wedge window 70, in an example embodiment, the planar front surface 86 is substantially parallel to the planar back surface 88. For example, in one embodiment, the planar front surface 86 and planar back surface 88 each have substantially parallel surfaces, wherein the planar front surface 86 of the wedge window 70 has an angle of approximately 1 degree. In another example embodiment, the planar front surface 86 and/or the planar back surface 88 has a wedge angle of approximately 0.25 degrees to approximately 1 degree. In yet another example embodiment, the planar front surface 86 and/or the planar back surface 88 has an angle of approximately 0.25 degrees to approximately 5 degrees. The wedge angle of surface 86, may range, however, from 0.25 degrees to 10 degrees for systems with F/#s in the range between F/200 and F/10. By “planar,” it is meant that the entire front surface 86 and the entire back surface 88 is flat and not undulating. Typically, the wedge window 70 includes any available optical glass refractive index, which is preferably approximately 1.5, but can range from 1.45 to 2.0. In one example embodiment, the wedge window 70 is N-BK7 glass with a refractive index of approximately 1.52 for much of the visible spectrum. An example of a commercially available wedge window is provided at www.thorlabs.com, part number WW11050.

As shown in FIGS. 5B-6C, to optimize the field-dependent alignment of the imaging system 20 and the illumination system 40 of an optical measurement system 10, a plurality of controlled and temporary misalignments, that is deviation of the illumination by a constant polar angle and a plurality of azimuthal angles, is purposefully introduced using the substrate 70 that can be adjusted within the system 10, such as wedge window 70. When the illumination distributions 50a and 50c are misaligned with the acceptance cones 54a and 54c of the imaging system, a change in signal intensity from the imager 22 is generated when the wedge window 70 is rotated. Thus, the optical alignment system 200, 300 using the adjustable substrate, provides feedback on the alignment of the imaging system 20 and illumination system 40. Such feedback provided by the optical alignment system 200, 300 includes data on the transmitted intensity as a function of alignment angle between the imaging system 20 and illumination system 40. Moreover, the feedback identifies the adjustments needed to be made to provide a telecentric system, for example, if the illumination is convergent or divergent.

The wedge window 70 deviates transmitted light by an angle that is largely insensitive to the angle of the incident light relative to the optical surfaces. Thus, the optical window 70 does not need to be placed in object space at a precise angle relative to the optical axis 28. Additionally, the translational position of the wedge window 70 can be varied since the wedge angle and therefore the induced angle of deviation, is constant throughout the field of view of the imaging system 20. Finally, the axial position of the wedge window 70 can be varied provided the illumination system 40 covers a large enough spatial extent. If the spatial extent is small, however, it is preferable to place the window 70 near the object plane to minimize signal loss due to translational displacement of the illumination relative to the imaging system 20.

By way of example, a wedge window 70 with refractive index of about 1.5 and a wedge angle of 1.5° has an absolute expected angular deviation of approximately 0.781°. Tilting the wedge window 70 away from the minimum deviation orientation by up to ±5° only incurs a change in deviation of about 0.006°, or 0.8% of the absolute deviation. Less severe wedge angles, for example, 0.5° are useful for certain applicable F/100 (NA≈1/(2*F-Number)=0.005) optical systems, and have even lower window tip/tilt sensitivity. In certain example embodiments, wedge windows 70 may be stacked to produce an overall, compound angle. For example, if the target wedge angle is 1°, two optical windows, each having and angle of 0.50°, can be stacked.

In one example embodiment, the wedge window 70 includes a fiducial mark 80 on the wedged window 70. The fiducial marker 80 in one example embodiment can indicate the thickest portion 82 or thinnest portion 84 of the wedge window 70, as shown in FIG. 7. As shown in FIGS. 7 and 8, fiducial marker 80 indicates the thinnest portion 84. The fiducial mark 80 can help determine which adjustments to make. For example, if the thickness gradient of the wedge window 70 is pointing horizontal when the intensity on the imager 22 is at a maximum or minimum, the horizontal angle between the imaging system 20 and illumination system 40 should be adjusted. The direction of the angular adjustment of the optical measurement system 10 can be determined by considering the geometry of the wedge window 70 and the optical measurement system 10, knowing which extreme (high or low) the wedge window 70 is positioned in, and understanding that the light is deviated towards the thick portion of the wedge window 70.

Once the wedge window 70 is placed in the object space of the system 10, the next step is to observe the relative intensity on the imager 22 as a function of the wedge rotation angle induced by rotating the wedge window 70. In an embodiment, the wedge window 70 is rotated about the substrate axis 68 that is substantially parallel to at least one of the illumination axis 48 and the optical axis 28. That is, the wedge window 70 may have a range of non-parallelism of the axis 68 to the illumination axis 48 and/or the optical axis 28 of 15 degrees or less, and preferably ±10 degrees or less. In another embodiment, the wedge window 70 is rotated about the substrate axis 68 between the illumination system 40 and the imaging system 20 where the substrate axis 68 is substantially perpendicular to the wedge window 70 and substantially parallel to at least one of the illumination axis 48 and the optical axis 28. That is, in one embodiment, the wedge window 70 is rotated about an axis 68 approximately perpendicular to its front 86 and back 88 surfaces and approximately parallel to the illumination axis 48 or the optical axis 28. Rotating the wedge window 70 induces different changes in the angle between the centerline axes 64a, 64b, and 64c and the centerline axes 60a, 60b, and 60c, respectively if the system is convergent or divergent, thus causing intensity changes on the imager 22 that are different for field points 76 and 78; however, if the system 10 is telecentric, the angle between the centerline axes 64a and 60a, 64b and 60b, and between the centerline axes 64c and 60c will be the same at any rotational position of the wedge window 70, resulting in the same intensity variations on the imager 22 for both field points 76, 74, and 78. Once an optimal alignment of the imaging system 20 with respect to the illumination system 40 is achieved so that the intensity on the imager 22 does not vary with rotational position of the wedge window 70, the wedge window 70 is removed from the optical path.

An optimally aligned system consisting of a rotationally symmetric illumination angular distribution 50a, 50b, and 50c and a rotationally symmetric acceptance cone 54a, 54b, 54c, respectively, will show no change in pixel intensity as the wedged window 70 is rotated through a full rotation. This is because the wedge-induced angle between the centerline axes 60a and 64a and between the centerline axes 60b and 64b and between the centerline axes 60c and 64c are constant for all azimuthal angles. Thus, the intersections of each pair of distributions 50a and 54a, 50b and 54b, and 50c and 54c provide a constant transmission of light. Two specific methods for obtaining and using pixel intensity data from the wedge window 70 at different rotational positions are provided below: manual rotation and motorized rotation.

Manual Rotation

In one example embodiment, the manual rotation method comprises manually rotating the wedged window 70 to induce a controlled deviation relative to the alignment of the imaging system 20 and the illumination system 40 and monitoring a change to the pixel intensity on the imager 22 in real time. By rotating the wedge window 70, a direction of deviation is determined and the wedge angle determines the relative magnitude of misalignment.

Motorized Rotation

In another example embodiment, changes to pixel intensity can be monitored while the wedge window 70 rotates freely or via an electromechanical mechanism. Pixel intensity analysis software may be used to further analyze and calculate the required adjustment.

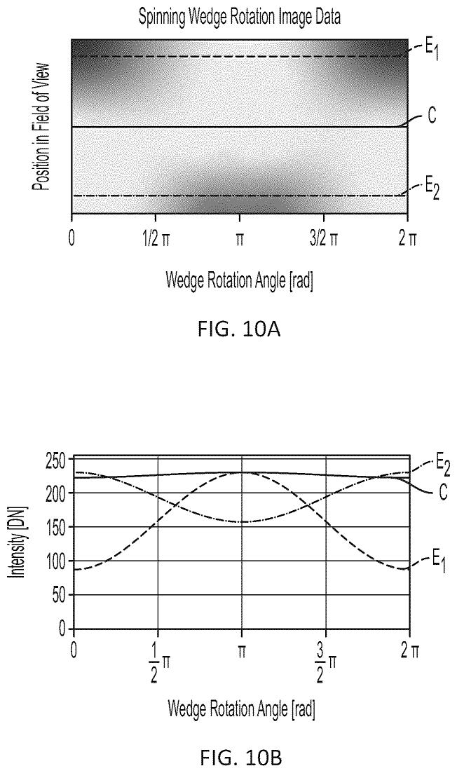

If the intensity is sampled many times per rotation, a dense trace can be created as illustrated in FIGS. 10A and 10B showing the digital number (DN) intensity on the imager 22 as a function of wedge rotation angle. Typically, when the imaging system 20 and the illumination system 40 of the optical measurement system 10 are close to alignment, there will be a monotonic intensity compared to the polar angle misalignment function in the region accessed by the wedge window 70. A substantial change in signal intensity may not be detected in one region of the image sensor, for example, corresponding to, for example, a location 74 as shown in FIG. 6C having illumination angular distribution 50b of the illumination system 40 while an intensity change is detected in the regions of the image sensor 22 corresponding to locations 76 and 78, as shown in FIGS. 6A and 6B, respectively, and to distributions 50a and 50b, respectively. In FIG. 10A, the intensity of a cross section of the field of view is shown as a function of the rotation angle of the tapered substrate 70 through one full rotation. The dashed line (E₁) near the top of the y-axis is produced by illumination angular distribution 50a located at one edge of the field of view corresponding to field point 76, the solid line (C) in the middle of the y-axis is produced by center illumination angular distribution 50b corresponding to field point 74, and the dotted-dashed line (E₂) at the bottom of the y-axis is produced by illumination angular distribution 50c located on another edge of the field of view on the opposite side of the center illumination angular distribution 50b corresponding to field point 78. As shown in FIG. 10B, a center trace (C) corresponding to location 74 of the tapered substrate 70 and illumination angular distribution 50b has nearly constant intensity indicating illumination angular distribution 50b is at least substantially aligned. When the illumination system is convergent or divergent, a change in signal intensity, however, is detected in at least two other regions of the image sensor corresponding to two other locations 76 and 78 and to distributions 50a and 50c, respectively. As shown in FIG. 10B, the edges E₁ and E₂, are out of phase indicating the imaging system 20 and the illumination system 40 are either convergent or divergent relative to each other. In one example embodiment, as shown in FIG. 10B, the edges E₁ and E₂ are out of phase by about π.

Field Dependent Alignment

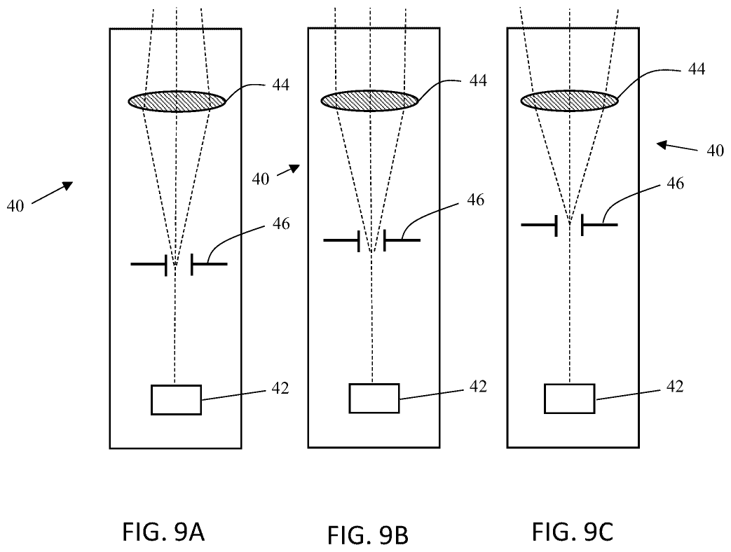

In, but not limited to the case illustrated in FIGS. 10A and 10B, where the edges E₁ and E₂ are out of phase by pi (π) and the center C has a constant intensity as described above, the illumination pupil position may be adjusted. Where there is a field-dependent alignment resulting from a convergent illumination system 40 and a telecentric imaging system 20 resulting in the edges of the field of view having opposite misalignment direction as shown in FIG. 9A, the illumination pupil 46 produced by an aperture stop at that location is too far away from the collimation lens 44. Thus, the pupil 46 can be moved closer to the collimation lens 44 to reduce the magnitude of field dependence and allow for an overall better alignment. Where the edges E₁, E₂ and the Center C all generally have substantially the same intensity changes with wedge window 70 rotation, the edges of the field of view are not misaligned as shown in FIG. 9B, the illumination pupil 46 produced by an aperture stop at that location does not need to be adjusted. Where there is a field-dependent alignment resulting from a divergent illumination system 40 from the edges of the field of view having opposite misalignment direction, as shown in FIGS. 5B and 9C, the illumination pupil 46 is too close to the collimation lens 44. Thus, the illumination pupil 46 can be moved farther away from the collimation lens 44 to reduce the magnitude of field dependence and allow for an overall better alignment. In one example embodiment, as the tapered substrate 70 is rotating, the distance of the illumination pupil 46 from the collimation lens 44 is adjusted until the intensities on the image sensor 22 corresponding to the angular distributions 50a, 50b, 50c are the same. In one example embodiment, the illumination pupil 46 is adjusted manually. In another example embodiment, the illumination pupil 46 is automatically adjusted by a processor in communication with a computer.

### Example

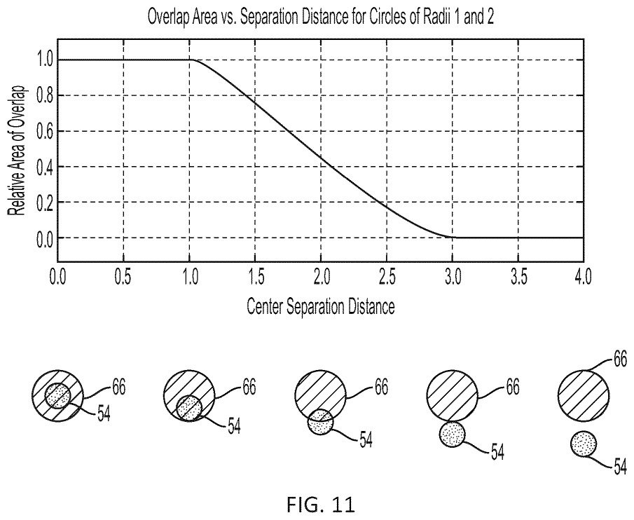

As one example, not meant to be limiting, an optical measurement system 10 using the optical alignment system 200 includes an imaging system 20 which is telecentric and an illuminator system 40 which may need to be angularly aligned to the imaging system 20 across the full field of view. That is, it is desired to achieve a substantially collimated, or telecentric, illuminator system 40. In the optical measurement system 10, it is assumed that the angular spread 66 (representing any of illumination angular distributions 66a, 66b, and 66c) of the illumination system 40 output is approximately twice the size of the angular spread 54 (representing the acceptance cone 54a, 54b, 54c corresponding with illumination angular distributions 66a, 66b, and 66c, respectively) of the imaging system's 20 acceptance cone as shown in FIG. 11, and that the illumination is angularly uniform within the angular extent. With this, the intensity change as a function of angular misalignment can be predicted as shown in FIG. 11. It should be appreciated that the wedge window 70 wedge angle should be chosen to induce a misalignment in roughly the center of the nearly linear ramp, about 2 arb. unit in FIG. 11 when the system is in acceptable alignment. This provides a monotonic change in intensity with small misalignments of the system 200 with the wedge window 70 present, which is desirable for further analysis. In this case, a higher magnitude of misalignment as induced by the wedge window 70 means less intensity on the image plane.

Observing a 1-dimensional array of pixels on the image sensor 22 that vertically spans the field of view one can create an intensity image as a function of wedge window rotation (X-axis) as shown in FIGS. 10A and 10B. Let us assume that the 0-radian rotational position deviates the beam upward (thickest portion of the wedge pointing up), and thus the π rotational position is deviating the beam downward. Considering the E₁ trace in FIG. 10B, the intensity is lowest and thus most misaligned at the 0-radian rotational position when the illumination is deviated upwards, away from the center of field of view. Correspondingly, the E₁ trace in FIG. 10B provides an intensity that is highest and thus least misaligned at the pi (π) rotational position when the illumination is deviated downwards, towards the center of field. In isolation, this data does not show whether the output beam of light is collimated. Rather, the data shows that in this part of the field of view, the illumination system 40 is aimed too far up relative to the imager 22. With no further information, it is possible to conclude that the illuminator is collimated, but the whole assembly is tipped too far upward.

Considering the E₂ trace in FIG. 10B, the E₂ trace has the opposite intensity pattern as the E₁ trace in that it is has the highest intensity at the 0-rotational position when deviated upward and the lowest intensity at the π-rotational position when deviated downward. This data shows that in this part of the field of view, the illuminator 38 is aimed too far down. As the E₁ trace correlates with the distribution 50a located near the top of the field of view and the E₂ trace correlates with the distribution 50c located near the bottom of the field of view as depicted in FIG. 5B, it can be determined that the illumination system 40 is pointed too far up at the top and too far down at the bottom. In other words, the illuminator is misaligned away from the center on both sides of the field of view. Additionally, the center trace (C) is relatively well aligned. Thus, it is understood that the output beam of light is diverging, and moving the illuminator pupil 46 away from the collimation lens 44 will reduce the magnitude of field dependence and allow for an overall better alignment.

As provided above, observing intensity variations generated from the rotating wedge window 70 on a 1-dimensional array of pixels on the image sensor 22 that vertically spans the field of view, a direction and relative magnitude of misalignment of the illumination system 40 can be ascertained at different regions within the field of view. More specifically, a direction and relative magnitude of misalignment of the illumination system 40 is ascertained for at least two regions in the field of view to determine if there is a field-dependent misalignment. In this example, the direction of misalignment will be along the direction of the thickness gradient of the wedge window 70, for example thickness gradient (TG) of FIG. 7, when the wedge window 70 is oriented such that a minimum intensity is achieved in a system where (the intensity at the image sensor 22 decreases as a magnitude of misalignment increases. The thickness gradient (TG) is perpendicular to the rotation axis 68. The misalignment magnitude can be seen in the amplitude of the intensity signal trace, e.g. a difference between the brightest and dimmest intensity indicates a larger misalignment magnitude. This is relative in a monotonic sense, but is more than likely not linear, meaning that twice the amplitude is not necessarily twice the misalignment magnitude. However, an amplitude of zero (no intensity variation) means there is substantially no misalignment.

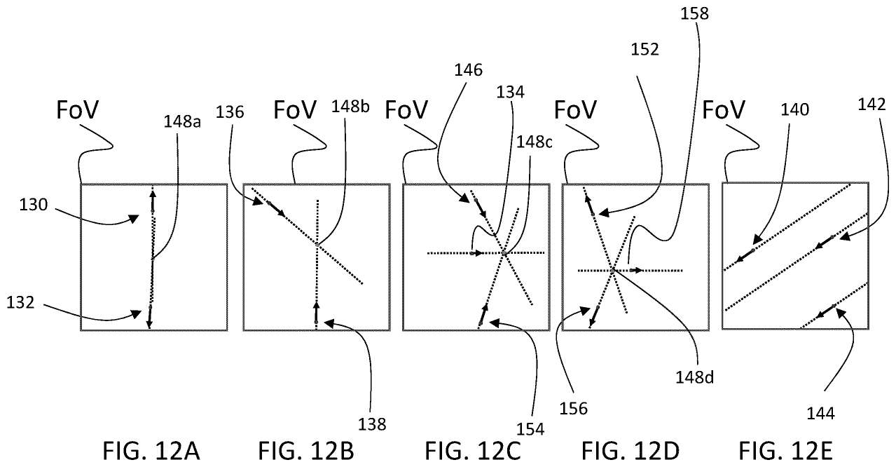

In another example embodiment, intensity variations generated from the rotating wedge window 70 can be observed on a 2-dimensional array of pixels on the image sensor 22 and a direction and relative magnitude of misalignment of the illumination system 40 can be ascertained at different regions within the field of view (FoV). When a 2-dimensional array of pixels on the image sensor 22 is used, however, two or more regions that are separated by a substantial portion within an extent of the field of view must be observed to achieve the greatest sensitivity to field-dependent misalignments. For example, as shown in FIGS. 12A-12E, the rotating wedge window 70 can be used to produce a misalignment direction of the illuminator 40 indicated by vectors shown as black arrows in the figures which represent deviation vectors at each region. Generally, as shown in FIG. 12A if the vectors at region 130 and region 132 in the field of view (FoV) (which are separated by a substantial portion within an extent of the field of view by having, in this example, a location on generally opposite ends of the field of view extent) are pointing away from an approximately common intersection point 148a, the illuminator 40 is divergent. Similarly, as shown in FIG. 12D, if the vectors in regions 152, 156, and 158 are pointing away from an approximately common intersection point 148d, the illuminator 40 is divergent. As shown in FIG. 12B, if the vectors in region 136 and region 138 point toward an intersection point 148b, the illuminator is convergent. Similarly, as shown in FIG. 12C, if the vectors at regions 134, 146, and 154 point toward an intersection point 148c, the illuminator is convergent. If the vectors are parallel in regions 140, 142, and 144 in the field of view (which are separated by a substantial portion within an extent of the field of view by having, in this example, three locations spaced about the field of view extent) as shown in FIG. 12E, and generally non-intersecting, the vectors will be in the substantially the same direction (i.e. not anti-parallel) and, further, indicates a field-independent misalignment wherein the illuminator 40 is collimated, but two system halves remain to be aligned.

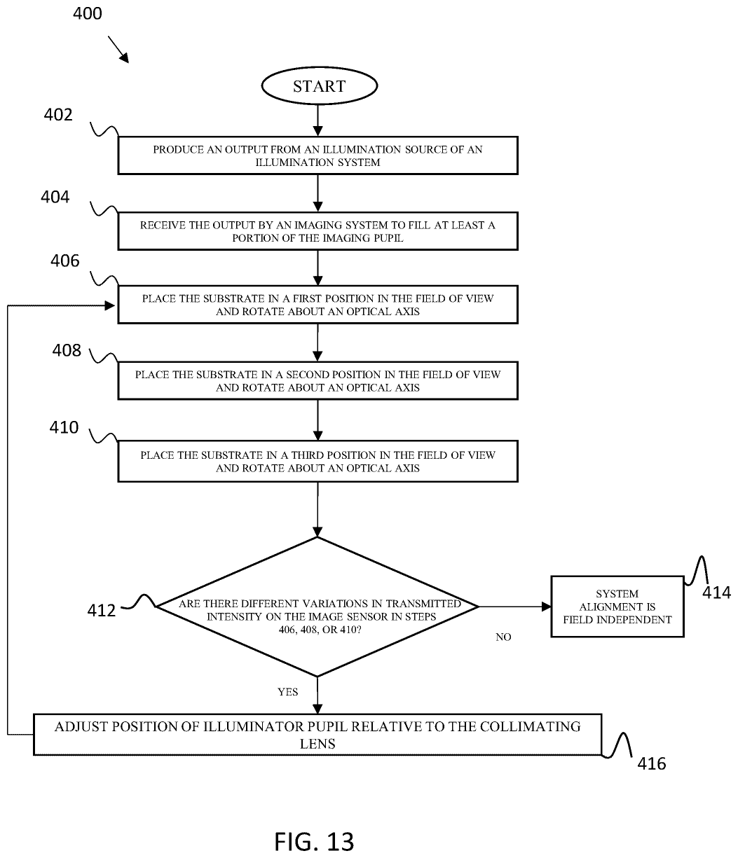

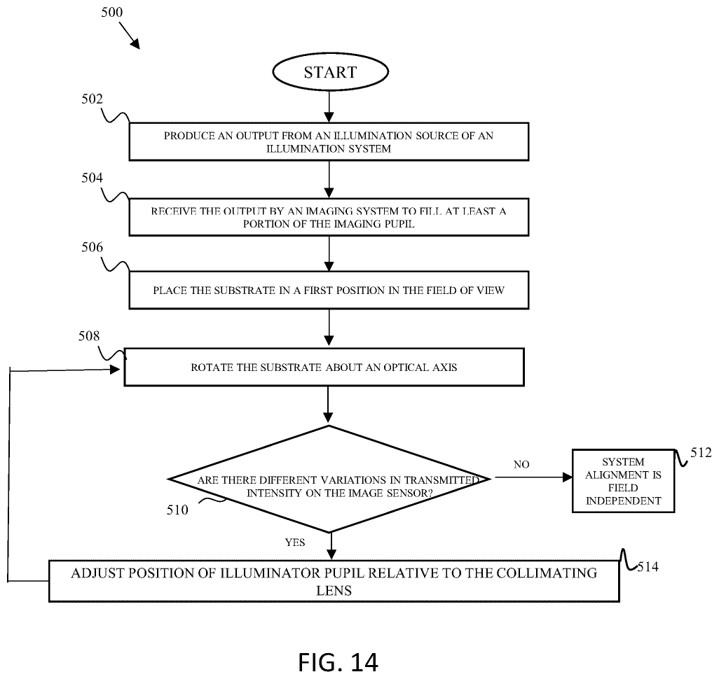

Flowcharts describing an example of the type of operations performed are presented in FIGS. 13 and 14. In FIG. 13, the method 400 begins with step 402 of producing an output from an illumination source 42 of an illumination system 40. According to step 404, the output is received by an imaging system 40 and fills at least a portion of the imaging pupil 26. A tapered substrate 70 is positioned in a first position in the field of view and rotated about an optical axis 28 according to step 406. In an example embodiment, the substrate 70 is a wedge window having planar, transmissive surfaces 86, 88. With the tapered substrate 70 in the first position in the field of view and rotated about the axis 68, it is observed whether there are variations in the transmitted intensity on the image sensor 22. According to step 408, the substrate is placed in a second position in the field of view and rotated about an axis 68 and, it is determined whether there are variations in transmitted intensity on the image sensor 22. Further, according to step 410, the substrate is placed in a third position in the field of view and rotated about an optical axis 68 and it is determined whether there are variations in transmitted intensity on the image sensor 22. In one example embodiment, the at least one of the first, second and third positions is in approximately the center of the field of view and the other two positions are in the field of view on opposite sides of the center. In one example embodiment, the third position is between the first and second positions. In another example embodiment, two or more regions that are separated by a substantial portion within an extent of the field of view are observed, but the third position is not necessarily between the first and second positions, for example as described with respect to FIGS. 12C-12E. If the observed variations corresponding to the multiple positions are substantially the same when the tapered substrate 70 is rotated, the system alignment is deemed to be field-independent having parallel axes wherein the illuminator is collimated and not divergent or convergent according to step 414. A further alignment between the illuminator system 40 and the imaging system 20 can then be undertaken.

If, on the other hand, different variations in transmitted intensities on the image sensor 22 are detected when the tapered substrate 70 is in the first and second positions, the illuminator 38 may be convergent or divergent and therefore, the position of the illumination pupil 46 relative to the collimating lens 44 may be adjusted to collimate the illumination system 40, according to step 416. If the illuminator 38 is convergent, for example, the distance between the illumination pupil 46 and the collimation lens can be decreased. If the illuminator 38 is divergent, the distance between the pupil 46 and the collimation lens can be increased. Once an adjustment to the aperture stop producing the illumination pupil 46 is made, the illumination system 40 can be checked to determine whether any differences in the variations in the transmitted intensity amongst the regions on the image sensor 22 remain. If different variations in the transmitted intensity on the image sensor 22 are detected at the at least first, second and third positions, steps 406-416 may be repeated. If variations in the transmitted intensity are observed to be the same at the multiple positions, the system 10 alignment is considered field-independent according to step 414. Although three positions are described, it should be appreciated that two or more positions of the tapered substrate 70 can be observed for application of this method.

Turning now to FIG. 14, the method 500 begins with step 502 of producing an output from an illumination source 42 of an illumination system 40. According to step 504, the output is received by an imaging system 40 and fills at least a portion of the imaging pupil 26. A tapered substrate 70 is positioned in a first position in the field of view according to step 506 and rotated about an axis 68 according to step 508. In an example embodiment, the substrate 70 is a wedge window having planar, transmissive surfaces 86, 88 and spans at least a substantial portion of the field of view. Step 510 determines whether there are variations in the transmitted intensity on the image sensor 22. Typically, pixels corresponding to at least two regions on the image sensor are observed. As an example, consider that three distinct regions are observed. The three different regions corresponding to three different portions of the tapered substrate 70 at three corresponding locations within the field of view. In one example embodiment, the third position is between the first and second positions. Typically, the third position is approximately in the center of the field of view and the other two positions are in the field of view on opposite sides of the center. In such an embodiment, if substantially the same variations are observed at all regions when the tapered substrate 70 is rotated, the system alignment is deemed to be field-independent wherein the illuminator is collimated and not divergent or convergent according to step 512. A further alignment between the illuminator system 40 and the imaging system 20 can then be undertaken. If, on the other hand, variations in transmitted intensities on the image sensor 22 are substantially different among the multiple regions, the illuminator 38 may be convergent or divergent in which case the position of the illumination pupil 46 relative to the collimating lens 44 may be adjusted to collimate the illumination system 40, according to step 514. If the illuminator 38 is convergent, for example, the distance between the illumination pupil 46 and the collimation lens 44 can be decreased. If the illuminator 38 is divergent, the distance between the pupil 46 and the collimation lens 44 can be increased. Once an adjustment to the aperture stop producing the illumination pupil 46 is made, the illumination system 40 can be checked to determine whether any variations in the transmitted intensity on the imagine sensor 22 remain. If variations in the transmitted intensity among the observed regions on the image sensor 22 are detected, steps 508-514 may be repeated. If consistent variations in the transmitted intensity amongst the regions are observed, the system 10 alignment is considered field-independent according to step 512. Although three positions are described, it should be appreciated that two or more positions of the image sensor 22 can be observed.

After the system is determined to be field independent according to FIGS. 13 and 12, the alignment between the imaging system 20 and the illumination system 40 is typically optimized before the test object 100 is measured by the optical measurement system 10. The alignment between the imaging system 20 and the illumination system 40 is optimized when substantially parallel axes of rotational symmetry between the illumination angular distribution and the imaging acceptance distribution in object space are obtained.

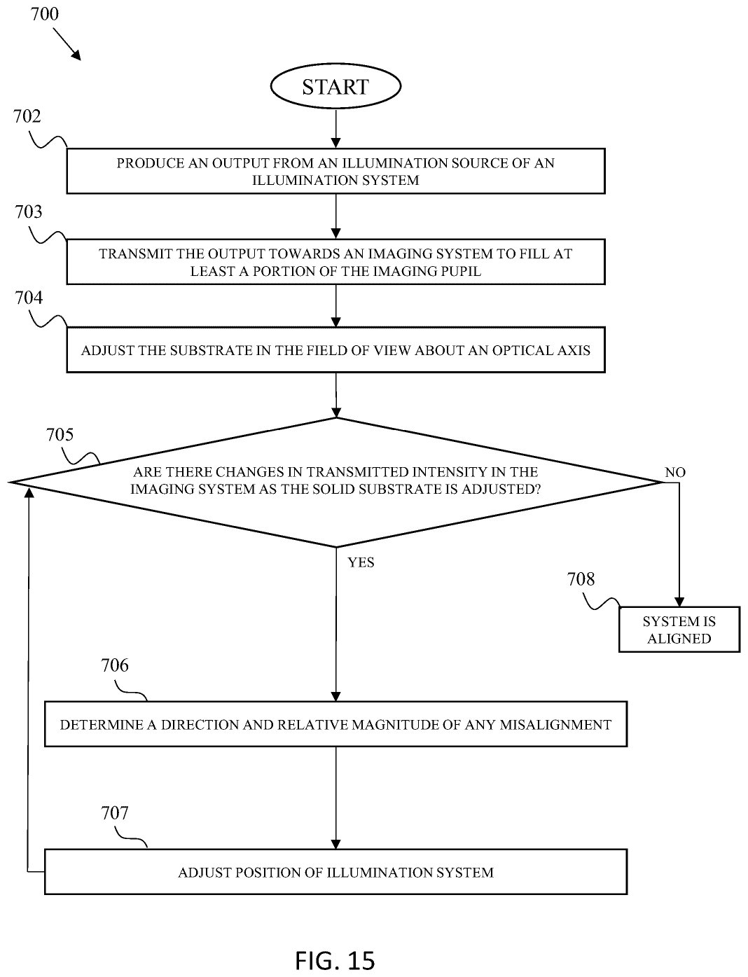

FIG. 15 is a flowchart showing an exemplary method 700 in accordance with an embodiment of the invention. The method 700 begins with step 702 of producing an output from an illumination source 42 of an illumination system 40 of an optical measurement system 10. The output is transmitted towards an imaging system 20 to fill at least a portion of the imaging pupil 24 according to step 703. A substrate, for example wedge window 70, is adjusted in the field of view about an optical axis 28 according to step 704. In one example embodiment, the step of adjusting the wedge window 70 includes rotating the wedge window 70 along a substantially perpendicular axis for at least one complete rotation.

Thereafter, in step 705, it is determined whether there are changes in the transmitted pixel intensity in the imaging system 20 as the wedge window 70 is adjusted. In one configuration, the signals of the locations of at least one fiducial marker 80 are detected and the signal between the locations is plotted. If no changes in pixel intensity are observed, the system 10 is deemed aligned according to step 708. If changes in pixel intensity are observed, then a direction and relative magnitude of misalignment are determined according to step 706 and the position of the illumination system 40 is adjusted according to step 707. In one example embodiment, the change of transmitted intensity on the image sensor 22 is observed as a function of the azimuthal deviation introduced by the wedge window 70. At that point, steps 705-707 are repeated until no further changes in the transmitted intensity in the imaging system 20 are detected, at which point the system 10 is deemed aligned according to step 708 and the wedge window 70 is removed from the optical path. The optical measuring system 10 is aligned when parallel axes of rotational symmetry 28, 48 in object space between the illumination angular distribution 50d and the imaging system acceptance cone 54d is obtained.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. An optical alignment system having a field of view comprising:
an illumination system having an illumination pupil and a light source configured to generate an output, wherein the illumination system produces a first illumination angular distribution having a first illumination axis, wherein the first illumination angular distribution is generally rotationally symmetric;
an imaging system having an imaging sensor comprising at least one detector element, an imaging pupil, and a first acceptance cone in object space of the imaging system having an optical axis, wherein at least a portion of the imaging pupil is filled by the illumination system output when a portion of the first illumination angular distribution overlaps with the first acceptance cone; and
a first tapered substrate having transmissive surfaces, the first tapered substrate removably disposed in object space between the illumination system and the imaging system, wherein the tapered substrate is rotated and a change in signal intensity is monitored to quantify field dependent alignment between the illumination system and the imaging system (i) in a first region of the image sensor corresponding to a first location or a first portion of the first substrate within the field of view; and (ii) in a second region of the image sensor corresponding to a second location or a second portion of the first substrate within the field of view.

2. The optical alignment system of claim 1 wherein the change in signal intensity is observed on a 1-dimensional array.

3. The optical alignment system of claim 1, wherein the change in signal intensity from the imaging sensor is observed on a 2-dimensional array.

4. The optical alignment system of claim 1, wherein the first tapered substrate is sized to span substantially the entire field of view, and wherein the first portion of the tapered substrate is within the field of view, and wherein the second portion is within the field of view.

5. The optical alignment system of claim 1, wherein the first tapered substrate is sized to span a portion of the field of view, and wherein the first tapered substrate is moveable within the field of view from the first location with the field of view to the second location within the field of view.

6. The optical alignment system of claim 1, wherein a change in signal intensity is monitored to quantify field dependent alignment between the illumination system and the imaging system in a third region of the image sensor corresponding to the first tapered substrate at a third location within the field of view, the third location between the first region and the second region.

7. The optical alignment system of claim 6, wherein a constant signal intensity in the third region of the image sensor, and a variation in signal intensity in the first and second regions of the image sensor that is out of phase by approximately one half of a complete rotation indicates the illumination system is convergent or divergent relative to the imaging system.

8. The optical alignment system of claim 1, wherein a change in signal intensity is monitored to quantify field dependent alignment between the illumination system and the imaging system in two or more regions that are separated by a substantial portion within an extent of the field of view.

9. The optical alignment system of claim 1, wherein the imaging system is telecentric.

10. The optical alignment system of claim 1, wherein the illumination system is telecentric.

11. The optical alignment system of claim 1, wherein the first tapered substrate is an optical window having a thick portion and a thin portion, and wherein the optical window includes a planar front surface and a planar back surface, wherein each surface has a non-zero angle between a surface normal of each surface in the range of approximately 0.25 degrees to 10 degrees.

12. A method of quantifying a field dependent alignment of an illumination system in an optical alignment system having a field of view, the method comprising the steps of:
producing an output from a light source of the illumination system having an illumination pupil and a collimation lens, the output having an illumination distribution having an illumination axis;
receiving by an imaging system the output from the illumination system, the imaging system having an imaging sensor, an imaging pupil and an acceptance cone having an optical axis, wherein at least a portion of the imaging pupil is filled by the output;
rotating a first tapered substrate having a thickness gradient between the illumination system and an imaging system about a substrate axis that is substantially parallel to at least one of the illumination axis and the optical axis, the first tapered substrate located in object space; and
monitoring intensity changes on a first region of the image sensor corresponding to the first tapered substrate at a first location within the field of view and a second region of the image sensor corresponding to the first tapered substrate at a second location within the field of view to quantify field dependent alignment between the illumination system and the imaging system.

13. The method of claim 12, further comprising the step of comparing (i) the intensity changes on the image sensor on the first region of the image sensor; and (ii) the intensity changes on the image sensor on the second region of the image sensor, wherein the intensity at the image sensor decreases as a magnitude of misalignment increases, and wherein the direction of the thickness gradient of the tapered substrate when the intensity is at a minimum indicates at least a first misalignment direction of the illumination system.

14. The method of claim 13, further comprising the step of moving the illumination pupil farther from the collimation lens if, in the optical alignment system where the first region having a first misalignment direction and the second region having a second misalignment direction are spaced from each other perpendicular to the optical axis in the field of view, the first misalignment direction and the second misalignment direction are pointing away from an approximately common intersection point between lines extending along the first and second misalignment directions at each of the first and second regions.

15. The method of claim 13, further comprising the step of moving the illumination pupil closer to the collimation lens if, in the optical alignment system where the first region having a first misalignment direction and the second region having a second misalignment direction are spaced from each other perpendicular to the optical axis in the field of view, the first misalignment direction and the second misalignment direction are pointing toward an approximately common intersection point between lines extending along the first and second misalignment directions at each of the first and second regions.

16. The method of claim 12, further comprising monitoring intensity changes on the image sensor corresponding to a third region of the image sensor corresponding to the first tapered substrate at the third location within the field of view to quantify field dependent alignment between the illumination system and the imaging system.

17. The method of claim 12, further comprising the step of comparing (i) the intensity changes on the image sensor on the first region of the image sensor; and (ii) the intensity changes on the image sensor on the second region of the image sensor, wherein the intensity at the image sensor increases as a magnitude of misalignment increases, and wherein the direction of the thickness gradient of the tapered substrate when the intensity is at a maximum indicates the direction of the illumination system misalignment.

18. The method of claim 17, further comprising the step of moving the illumination pupil farther from the collimation lens if, in the optical alignment system where the first region having a first misalignment direction and the second region having a second misalignment direction are spaced from each other perpendicular to the optical axis in the field of view, the first misalignment direction and the second misalignment direction are pointing away from an approximately common intersection point between lines extending along the first and second misalignment directions at each of the first and second regions.

19. The method of claim 17, further comprising the step of moving the illumination pupil closer to the collimation lens if, in the optical alignment system where the first region having a first misalignment direction and the second region having a second misalignment direction are spaced from each other perpendicular to the optical axis in the field of view, the first misalignment direction and the second misalignment direction are pointing toward an approximately common intersection point between lines extending along the first and second misalignment directions at each of the first and second regions.

20. The method of claim 12, wherein the intensity changes on the image sensor are monitored on a 1-dimensional array.

21. The method of claim 12, wherein the intensity changes on the image sensor are monitored on a 2-dimensional array.

22. The method of claim 12, further comprising the step of selecting the first tapered substrate to comprise an optical window having a thick portion and a thin portion, and wherein the optical window includes a planar front surface and a planar back surface, wherein each surface has a non-zero angle between a surface normal of each surface in the range of approximately 0.25 degrees to 10 degrees.

23. The method of claim 12, further comprising moving the first tapered substrate to the second location within the field of view before monitoring intensity changes on the second region of the image sensor corresponding to the first tapered substrate at a second location within the field of view.

24. The method of claim 12, further comprising the step of locating the first tapered substrate in at least substantially all of the field of view, wherein the first tapered substrate is sized to span substantially all of the field of view.

25. The method of claim 12, further comprising the steps of:
rotating the first tapered substrate between the illumination system and the imaging system about a substrate axis that is substantially parallel to at least one of the illumination axis and the optical axis, the first tapered substrate located in object space between the illumination system and an imaging system;
detecting on an image sensor whether changes in transmitted intensity in the imaging system occur as the first tapered substrate is rotated; and
if changes in transmitted intensity are detected, determining a direction and relative magnitude of misalignment between the illumination system and imaging system.

26. The method of claim 25, wherein the first tapered substrate is a wedge window having a thick portion and a thin portion, wherein the thick portion includes at least one fiducial marker that generates a signal of a location of the at least one fiducial marker when the wedge window is rotated.

27. The method of claim 25, further comprising the step of detecting the signals at the locations of the at least one fiducial marker and plotting the signal based on a rotation angle estimated by the at least one fiducial marker location.
